(19) United States
(12) Patent Application Publication
(10) Pub. No.: US 2026/0250985 A1
(43) Pub. Date: Aug. 27, 2026

(54) LATCH ASSEMBLY AND ACCESS MEMBER SYSTEM

(71) Applicant: ASSA ABLOY Global Solutions AB, Stockholm (SE)

(72) Inventors: Charlie Pigonska Haagendrup, Jyllinge (DK); Josef Snabb, Göteborg (SE); Sandra Molander, Göteborg (SE)

(21) Appl. No.: 19/162,495

(22) PCT Filed: Dec. 20, 2023
(86) PCT No.: PCT/EP2023/086958

§ 371 Date: Sep. 5, 2025

(30) Foreign Application Priority Data
Mar. 7, 2023 (SE) 2350255-2

(51) Int. Cl. E05B 55/00; E05B 47/00

(52) U.S. Cl. CPC E05B 55/00; E05B 47/0012; E05B 2047/0024

(57) ABSTRACT

A latch assembly (10a; 10b) comprising a base structure 10b(12 ); an elongated latch slider (14a; 14b) including a slider feature (62a; 62b) and being slidable between a free position (18) and a latching position (40); and a lock device (26) including an electromechanical actuator 22(72 ) and a lock element (74a; 74b) movable by the actuator between an unlocked position (92), and a locked position (96) for engaging the slider feature to prevent movement of the latch slider from the latching position to the free position; wherein the lock device further comprises a drive feature (76) driven by the actuator; wherein the lock element comprises a driven feature (86) arranged to be contacted and driven by the drive feature; and wherein a base clearance (98) between the lock element and the base structure is smaller than a drive clearance (104) between the drive feature and the driven feature.

### TECHNICAL FIELD

The present disclosure generally relates to latch assemblies. In particular, latch assemblies comprising an elongated latch slider and a lock device for locking the latch slider, are provided.

### BACKGROUND

Latch assemblies are often used for keeping different types of doors locked. A latch assembly comprises a base structure and a latch slider that can be extended from the base structure in a sliding movement. Normally, a grip portion is used for manually sliding the latch slider between free (unlatching) position and a latching position. A latch assembly may further comprise an electronic lock device for locking the latch slider in the latching position.

U.S. Pat. No. 11,512,498 B2, the content of which is incorporated herein by reference in its entirety, discloses a latch assembly comprising a main latch, an elongated latch slider including a protruding lug, a motor and a head. The latch slider is provided with a protruding lug that will engage the head in a locked position of the head. By rotating the head to an unlocked position, the protruding lug of the latch slider can pass by the head such that the latch slider can slide to a position where the latch slider is no longer received in an aperture in a door frame.

### SUMMARY

One object of the invention is to provide an improved latch assembly.

A further object of the invention is to provide an improved access member system comprising a latch assembly.

These objects are achieved by the latch assembly according to appended claims 1, 7, 12, 15, 19 and 23, and by the access member system according to appended claim 32.

The invention is based on the realization that by constraining movements of a lock element relative to a base structure in a latch assembly, and by providing a play between a drive feature and a driven feature upstream of the lock element, a risk that shocks imposed on a latch slider damages an actuator can be reduced or eliminated.

The invention is further based on the realization that by providing a latch assembly comprising a lock element for locking a latch slider in a latching position by cooperation between a lock element side surface and a stop surface of a slider feature on the latch slider, and by providing an angle between the lock element side surface and the stop surface, a risk of jamming of the lock element can be reduced.

The invention is further based on the realization that by providing a latch assembly comprising a lock device for locking a latch slider in a latching position, and by providing a latch hole in the latch slider and a base hole in a base structure, a redundant lock functionality is enabled, for example such that the latch slider can be locked by passing a shackle of a padlock through the latch hole and the base hole.

The invention is further based on the realization that by providing a latch assembly having a lock device including a lock element contacting a top surface of a latch slider in a locked position, a time of movement of the lock element from an unlocked position to the locked position can be used as an indicator of the position of the lock element instead of a dedicated sensor.

The invention is further based on the realization that by providing a latch assembly having a latch slider comprising an opening for being engaged by a slider feature of the latch slider, and where a protection element of a base structure extends through the opening and protecting the lock element, security of the latch assembly is improved.

The invention is further based on the realization that by providing a latch assembly comprising a rotatable lock element rotationally supported on one side by an actuator and rotationally supported on an opposite side by a support structure, the latch assembly is made more robust.

According to a first aspect, there is provided a latch assembly comprising a base structure; an elongated latch slider including a slider feature and being slidable relative to the base structure along a latch axis between a free position and a latching position; and a lock device including an electromechanical actuator and a lock element movable by the actuator between an unlocked position where the lock element allows movement of the latch slider between the free position and the latching position, and a locked position for engaging the slider feature to prevent movement of the latch slider from the latching position to the free position; wherein the lock device further comprises a drive feature driven by the actuator; wherein the lock element comprises a driven feature arranged to be contacted and driven by the drive feature; and wherein a base clearance between the lock element and the base structure is smaller than a drive clearance between the drive feature and the driven feature.

When the latch slider adopts the latching position and the lock element adopts the locked position, the slider feature may be brought into contact with the lock element when the latch slider is forced from the latching position towards the free position. The lock element may thus be referred to as a blocker. When the latch slider adopts the latching position, the lock element may be positioned between the actuator and the slider feature along the latch axis.

In case the latch assembly is tampered with by applying forces to the latch slider, the slider feature may be brought into contact with the lock element. However, due to the base clearance being smaller than the drive clearance, any forces applied to the latch slider will be absorbed by the base structure stopping the lock element before without these forces being transmitted by the lock element to the actuator. The design of the latch assembly thus prevents shock loads (forces and torques) imposed on the latch slider from damaging the actuator. As used herein, a clearance may be defined as a maximum distance between adjacent surfaces of mating parts.

The base structure may comprise a main latch. Alternatively, or in addition, the base structure may comprise a first guide member and a second guide member. In this case, the lock element may be positioned between the first and second guide members, e.g., in a direction parallel with the latch axis.

The lock element may be made of metal, such as steel, or reinforced plastics. Alternatively, or in addition, at least the first and second guide members may be made of metal, such as steel, or reinforced plastics.

The slider feature may be a protrusion. According to one example, the slider feature is a protruding tab, e.g., protruding up from a top surface of the latch slider.

The base clearance may be substantially parallel with, or parallel with, the latch axis.

The lock element may be rotatable about an actuator axis. The drive clearance may be a circumferential clearance with respect to the actuator axis.

The actuator axis may be substantially parallel with, or parallel with, the latch axis.

The lock element may be rotatable about the actuator axis.

According to a second aspect, there is provided a latch assembly comprising a base structure; an elongated latch slider including a slider feature and being slidable relative to the base structure along a latch axis between a free position and a latching position; and a lock device including an electromechanical actuator and a lock element movable by the actuator between an unlocked position where the lock element allows movement of the latch slider between the free position and the latching position, and a locked position for engaging the slider feature to prevent movement of the latch slider from the latching position to the free position; wherein the slider feature comprises a stop surface; wherein the lock element comprises a lock element side surface facing towards the stop surface when the latch slider is in the latching position and the lock element is in the locked position; and wherein the lock element side surface and the stop surface are angled relative to each other.

In case the lock element side surface and the stop surface are parallel and brought into contact with each other, a frictional force resisting movements of the lock element will be relatively high. By instead providing an angle between the lock element side surface and the stop surface, the frictional force resisting movements of the lock element can be significantly reduced. This enables the lock element to be moved from the locked position to the unlocked position even if a force is imposed on the latch slider towards the free position such that the stop surface is forced against the lock element side surface. Thus, a risk that the actuator jams due to friction can be reduced. As a further effect, a rating of the lock device can be reduced, for example a power output or a size thereof.

Each of the lock element side surface and the stop surface may be flat. The latch assembly may for example provide a point contact or a line contact between the lock element side surface and the stop surface. For example, a corner of the lock element side surface may contact the stop surface (or vice versa) to provide a point contact, or an edge of the lock element side surface may contact the stop surface (or vice versa) to provide a line contact.

The lock element side surface and the stop surface may form a V-shape. The V-shape may point away from the actuator, such as away from an actuator axis thereof.

The lock element side surface may be perpendicular to the latch axis. In this case, the stop surface may be non-perpendicular to the latch axis. Alternatively, the stop surface may be perpendicular to the latch axis. In this case, the lock element side surface may be non-perpendicular to the latch axis.

The lock element side surface and the stop surface may for example be angled at least 2° and/or less than 20°, such as at least 3° and/or less than 10°, such as 5°, relative to each other.

According to a third aspect, there is provided a latch assembly comprising a base structure; an elongated latch slider including a slider feature and being slidable relative to the base structure along a latch axis between a free position and a latching position; and a lock device including an electromechanical actuator and a lock element movable by the actuator between an unlocked position where the lock element allows movement of the latch slider between the free position and the latching position, and a locked position for engaging the slider feature to prevent movement of the latch slider from the latching position to the free position; wherein the latch slider comprises a latch hole, wherein the base structure comprises a base hole, and wherein the latch hole and the base hole are arranged to simultaneously receive a shackle of a padlock therethrough.

When the shackle or a similar locking member is passed through the latch hole and the base hole, the latch slider is prevented from moving relative to the base structure along the latch axis. The latch hole and the base hole enable a redundant and more versatile lock functionality of the latch assembly. User experience is therefore improved.

The latch hole and the base hole may be arranged to receive the shackle therethrough when the latch slider adopts the latching position. The latch hole and the base hole may be aligned when the latch slider adopts the latching position.

Alternatively, the latch hole and the base hole may be arranged to receive the shackle therethrough when the latch slider adopts the free position. In this case, the latch hole and the base hole may be aligned when the latch slider adopts the free position.

The latch slider may comprise a grip portion. In this case, the latch hole may be provided in the grip portion.

According to a fourth aspect, there is provided a latch assembly comprising a base structure; an elongated latch slider including a slider feature and being slidable relative to the base structure along a latch axis between a free position and a latching position; and a lock device including an electromechanical actuator and a lock element movable by the actuator between an unlocked position where the lock element allows movement of the latch slider between the free position and the latching position, and a locked position for engaging the slider feature to prevent movement of the latch slider from the latching position to the free position; wherein the latch slider comprises a top surface; wherein the slider feature protrudes above the top surface; and wherein the lock element contacts the top surface in the locked position.

If for example the actuator is an electric motor, an increased current of the motor may be indicative of when the lock element is driven against a stop. Since the slider feature protrudes above the top surface, a first distance moved by the lock element from the unlocked position into contact with the slider feature will be shorter than a second distance moved by the lock element from the unlocked position to the locked position. A first time and a second time for the lock element to move through the first distance and the second distance, respectively, can be determined, e.g., by tests. In case a movement time of the lock element corresponds to the first time, it can be concluded, without a dedicated sensor, that the lock element has been stopped by the slider feature due to an incorrect positioning of the latch slider along the latch axis despite the actuator has been commanded to move the lock element to the locked position. In this case, there is a risk that a human user can push the latch slider from the free position to the latching position. A warning may then be issued by the lock device. On the other hand, in case a movement time of the lock element corresponds to the second time, it can be concluded that the lock element has successfully reached the locked position without requiring a dedicated sensor.

The features of the latch assembly according to each of the first to fourth aspects may be combined in any way. For example, the latch assembly according to each of the first to fourth aspects may be the same.

The lock element may be L-shaped. In case the lock element is rotatable about an actuation axis, the actuation axis may be positioned at one end of the L-shape and the opposite end of the L-shape may be configured to contact the top surface.

The lock device may comprise a button. In this case, the lock device may be configured to actuate the actuator to move the lock element from the unlocked position to the locked position in response to manual actuation of the button. For example, actuation of the button may actuate a switch of a control system of the lock device.

The lock element may be rotatable between the unlocked position and the locked position. As one conceivable alternative, the lock element may be linearly movable between the unlocked position and the locked position.

According to a fifth aspect, there is provided a latch assembly comprising a base structure; an elongated latch slider including a slider feature and being slidable relative to the base structure along a latch axis between a free position and a latching position; and a lock device including an electromechanical actuator and a lock element movable by the actuator between an unlocked position where the lock element allows movement of the latch slider between the free position and the latching position, and a locked position for engaging the slider feature to prevent movement of the latch slider from the latching position to the free position; wherein the latch slider comprises an opening including the slider feature; and wherein the base structure comprises a protection element extending through the opening and protecting the lock element.

Due to the protection element protecting the lock element, a resistance against lock picking of the latch assembly is increased. For example, the protection element makes it much more difficult to access the lock element to tamper with the lock element using a steel wire or similar element. The lock element may pass through the opening and contact the protection element in the locked position.

Moreover, the design of the latch assembly according to the fifth aspect enables the lock element to be moved only a relatively short distance between the unlocked position and the locked position. The latch assembly is therefore energy efficient.

The features of the latch assembly according to the fifth aspect may be combined with any features of the first to third aspects.

The opening may include a slot extending in parallel with the latch axis. In these cases, the protection element may be positioned in the slot. When the latch slider moves between the free position and the latching position, the protection element may travel in the slot with respect to the latch slider.

The base structure may comprise a base plate. In these cases, the protection element may be a flange protruding from the base plate. The protection element may be integrally formed with the base plate.

The lock element may be rotatable around an actuator axis.

The base structure may comprise a gap between a body section of the base plate and the protection element. In these cases, the lock element may comprise a substantially planar, or planar, lock element end surface substantially parallel with, or parallel with the actuator axis. Moreover, in these cases, the lock element end surface may face the gap in the locked position of the lock element. Thus, should a lock picking element be introduced into the gap, the lock picking element will merely contact a planar surface of the lock element making lock picking more difficult.

The lock element may be droplet-shaped. A wide section of the droplet shape may engage the slider feature. In case the lock element is rotatable around the actuator axis, the actuator axis may be arranged at a narrow section of the droplet shape.

The base plate may be made of a sheet material, such as sheet metal.

According to a sixth aspect, there is provided a latch assembly comprising a base structure; an elongated latch slider including a slider feature and being slidable relative to the base structure along a latch axis between a free position and a latching position; and a lock device including an electromechanical actuator and a lock element rotatable by the actuator around an actuator axis between an unlocked position where the lock element allows movement of the latch slider between the free position and the latching position, and a locked position for engaging the slider feature to prevent movement of the latch slider from the latching position to the free position; wherein the base structure comprises a support structure arranged to support rotation of the lock element around the actuator axis; and wherein the actuator and the support structure are positioned on opposite sides of the lock element.

The support structure provides a counter support for the lock element in addition to a support provided by the actuator. Due to the support structure, the lock element is made much more resilient against torques acting on the lock element around axes transverse to the actuator axis. Moreover, due to the support structure taking up loads acting on the lock element, the actuator can be protected. Examples of sources of loads acting on the lock element may include tampering attempts on the latch assembly and forceful use of the latch assembly.

The features of the latch assembly according to the sixth aspect may be combined in any way with any feature of the first to fifth aspects.

The lock element may comprise a lock element shaft concentric with the actuator axis. In these cases, the support structure may support the lock element shaft.

The base structure may comprise a housing. In these cases, the support structure may be locked to the housing. Alternatively, the support structure may be constituted by a wall of the housing.

The housing may be molded, e.g., in plastic. Alternatively, or in addition, the support structure may comprise a support plate. By locking the support plate in a molded housing, rigidity of the support structure is improved without complicating a molding process of the housing.

The support plate may be oriented transverse to the actuator axis.

The base structure may comprise a base plate. In these cases, the support structure may be supported by the base plate.

The base structure may further comprise a lock element chamber at least partly accommodating the lock element. In these cases, the base structure may comprise at least one closed chamber. Moreover, in these cases, the actuator may be accommodated in one of the at least one closed chamber. Moreover, in these cases, each closed chamber may be sealingly closed to the lock element chamber.

The support structure may be accommodated in the lock element chamber.

According to a seventh aspect, there is provided an access member system comprising a latch assembly according to any of first to fifth aspects and an access member. In this case, the base structure may be fixed to the access member. The access member system may further comprise a frame. The access member may be movable relative to the frame, such as by rotation or linear motion. The access member may be a door leaf or window.

### BRIEF DESCRIPTION OF THE DRAWINGS

Further details, advantages and aspects of the present disclosure will become apparent from the following description taken in conjunction with the drawings, wherein:

FIG. 1: schematically represents a front perspective view of a latch assembly when a latch slider is in a free position;

FIG. 2: schematically represents a front perspective view of the latch assembly when the latch slider is in a latching position;

FIG. 3: schematically represents a front view of an access member system comprising the latch assembly;

FIG. 4: schematically represent a front view of a padlock;

FIG. 5: schematically represents a perspective view of the latch slider;

FIG. 6: schematically represents a partial perspective view of a base plate of the latch assembly;

FIG. 7: schematically represents a rear view of the latch assembly;

FIG. 8: schematically represents a block diagram of a lock device of the latch assembly;

FIG. 9: schematically represents a partial and cross-sectional perspective view of the latch assembly when a lock element of the latch assembly is in an unlocked position;

FIG. 10: schematically represents a partial and cross-sectional perspective view of the latch assembly when the lock element is in a locked position;

FIG. 11: schematically represents a partial and cross-sectional side view of the latch assembly when the lock element is in the locked position;

FIG. 12: schematically represents a perspective view of an actuator of the lock device;

FIG. 13: schematically represents a perspective view of the lock element;

FIG. 14: schematically represents a partial and cross-sectional front view of a drive feature of the lock device and a driven feature of the lock element;

FIG. 15: schematically represents a perspective front view of a latch assembly according to a further example comprising a latch slider and a base plate;

FIG. 16: schematically represents a perspective front view of the latch slider in FIG. 16;

FIG. 17: schematically represents a partial perspective front view of the base plate in FIG. 15;

FIG. 18: schematically represents a perspective end view of the base plate in FIG. 15;

FIG. 19: schematically represents a partial cross-sectional end view of the latch assembly in FIG. 15;

FIG. 20: schematically represents a partial perspective rear view of the latch assembly in FIG. 15;

FIG. 21: schematically represents a perspective side view of a lock element of the latch assembly in FIG. 15;

FIG. 22: schematically represents a perspective front view of components of the latch assembly in FIG. 15;

FIG. 23: schematically represents a partial and cross-sectional perspective front view of the latch assembly in FIG. 15;

FIG. 24: schematically represents a partial and cross-sectional perspective end view of the latch assembly in FIG. 15;

FIG. 25: schematically represents a perspective front view of a removal tool according to one example;

FIG. 26: schematically represents a perspective rear view of the removal tool in FIG. 25;

FIG. 27: schematically represents a perspective front view of a removal tool according to a further example; and

FIG. 28: schematically represents a perspective rear view of the removal tool in FIG. 27.

### DETAILED DESCRIPTION

In the following, latch assemblies comprising an elongated latch slider and a lock device for locking the latch slider, will be described. The same or similar reference numerals will be used to denote the same or similar structural features.

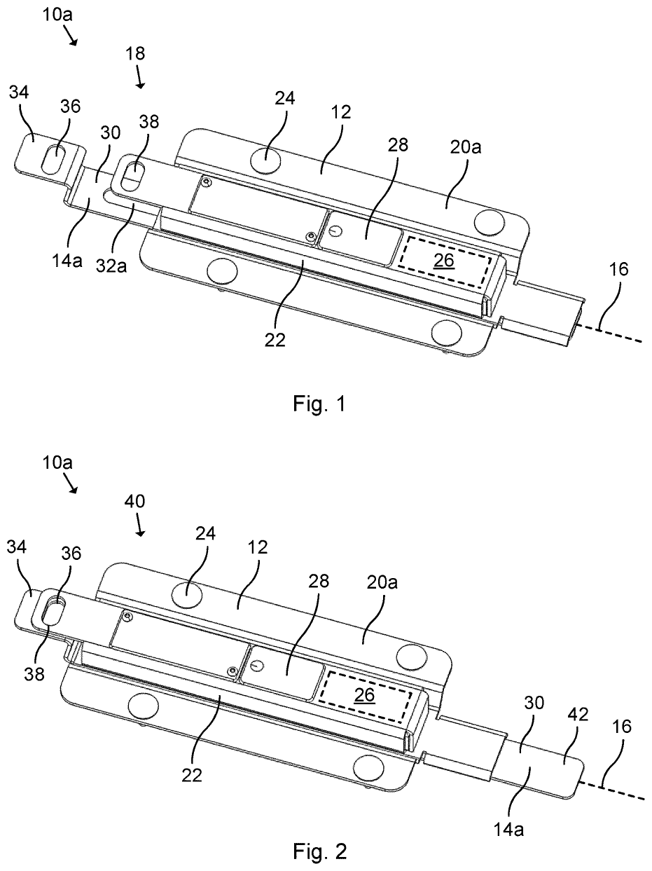

FIG. 1 schematically represents a front perspective view of a latch assembly 10a according to one example. The latch assembly 10a comprises a base structure 12 and an elongated latch slider 14a. The latch slider 14a is movable relative to the base structure 12 along a latch axis 16. In FIG. 1, the latch slider 14a is in a free position 18. As can be gathered from FIG. 1, the latch slider 14a of this example defines a longitudinal axis concentric with the latch axis 16.

The base structure 12 of this specific and non-limiting example comprises a base plate 20a and a housing 22. The base plate 20a can be secured to an access member by front bolts 24. The housing 22 is secured to the base plate 20a, e.g., by rear bolts.

The latch assembly 10a further comprises a lock device 26. In this example, the lock device 26 is contained inside the housing 22. The latch assembly 10a of this example further comprises an optional button 28.

The latch slider 14a of this example comprises a top surface 30 and a slot 32a extending in parallel with the latch axis 16. The latch slider 14a of this example further comprises a grip portion 34. The grip portion 34 is here parallel with, and offset from, the top surface 30. The grip portion 34 is configured to be gripped by fingers of a human user.

The latch slider 14a of this example further comprises a latch hole 36. The latch hole 36 is here provided in the grip portion 34. The base structure 12 of this example further comprises a base hole 38. In this example, the latch hole 36 is offset from the base hole 38 along the latch axis 16 when the latch slider 14a adopts the free position 18.

FIG. 2 schematically represents a front perspective view of the latch assembly 10a. In FIG. 2, the latch slider 14a is in a latching position 40. The latch slider 14a is thus movable along the latch axis 16 relative to the base structure 12 between the free position 18 and the latching position 40. In the latching position 40, a latching end 42 of the latch slider 14a protrudes from the base structure 12, e.g., for engaging a strike of a frame.

In this example, the latch hole 36 is aligned with the base hole 38 along the latch axis 16 when the latch slider 14a adopts the latching position 40. A shackle of a padlock can be passed through each of the latch hole 36 and the base hole 38 to lock the latch slider 14a in the latching position 40.

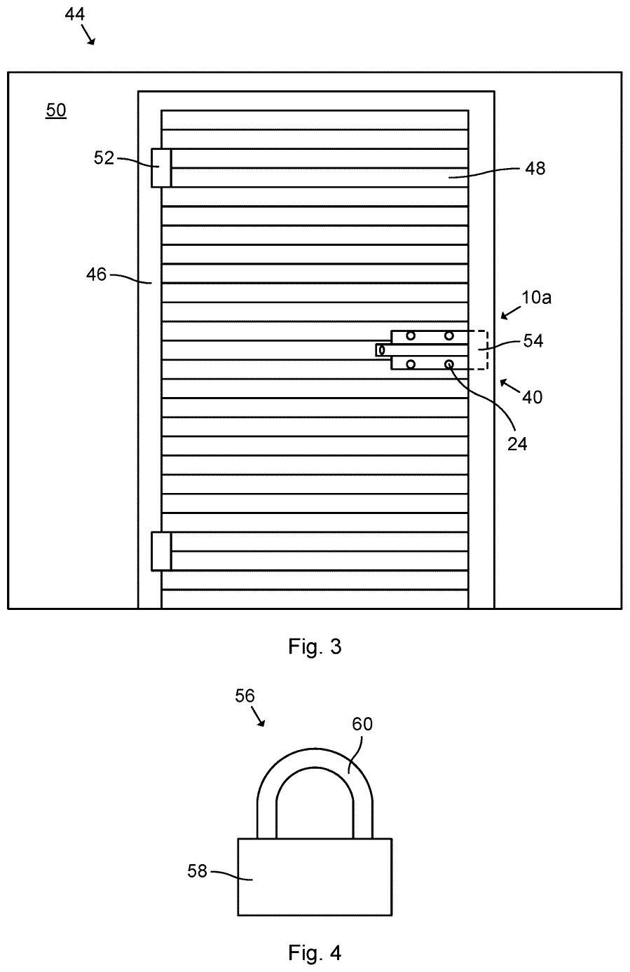

FIG. 3 schematically represents a front view of an access member system 44 according to one example. The access member system 44 comprises the latch assembly 10a.

The access member system 44 comprises a frame 46 and a door leaf 48 movable relative to the frame 46. The door leaf 48 is one example of an access member. The frame 46 is here provided in a wall 50. The door leaf 48 of this example is a corrugated door leaf and is rotatable relative to the frame 46 via hinges 52. The latch assembly 10a is secured to the door leaf 48, e.g., by threadingly engaging the front bolts 24 passing through the base plate 20a with respective nuts at an inside of the door leaf 48. When the latch assembly 10a is secured to the door leaf 48, the base structure 12 is fixed to the door leaf 48. In FIG. 3, the latch slider 14a is in the latching position 40 engaging the strike 54 in the frame 46. The door leaf 48 is thereby locked.

FIG. 4 schematically represent a front view of a padlock 56. The padlock 56 comprises a body 58 and a shackle 60. The padlock 56 of this example may be used to lock the latch slider 14a in the latching position 40 as described above.

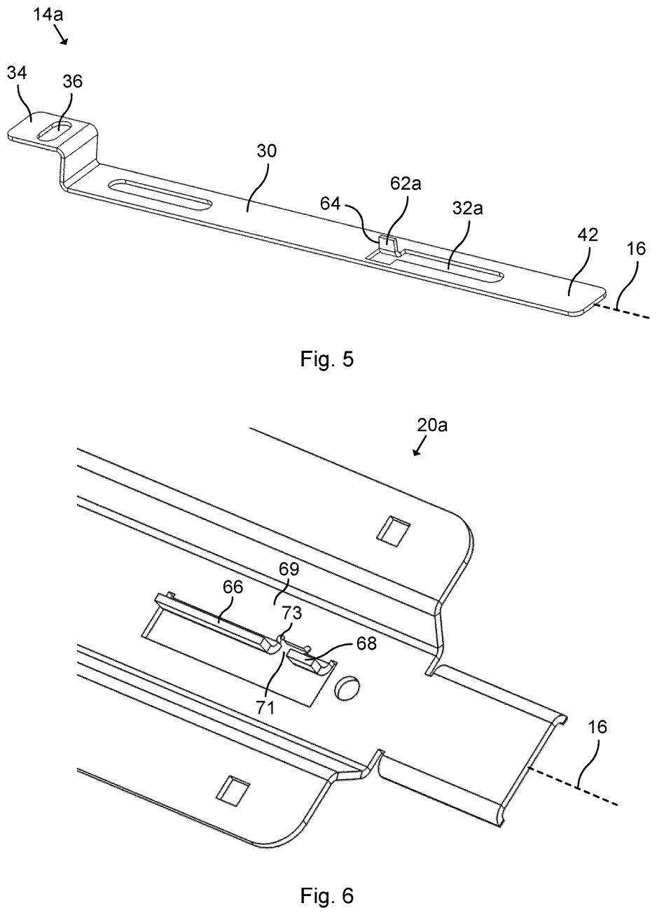

FIG. 5 schematically represents a perspective view of the latch slider 14a. In FIG. 5, it can be seen that the latch slider 14a comprises two slots 32a. The slots 32a are aligned with, and offset along, the latch axis 16.

Moreover, the latch slider 14a comprises a slider feature 62a. The slider feature 62a, here exemplified as a protruding tab, protrudes up from the top surface 30. The slider feature 62a comprises a stop surface 64, here facing towards the grip portion 34. The entire latch slider 14a as shown in FIG. 5 can be formed from a single piece of sheet metal, such as steel.

FIG. 6 schematically represents a partial perspective view of the base plate 20a. The base structure 12, here the base plate 20a thereof, comprises a first guide member 66 and a second guide member 68. The housing 22, the base plate 20a, the first guide member 66 and the second guide member 68 of the base structure 12 are thus fixed to each other. The first and second guide members 66 and 68 are aligned with, and offset along, the latch axis 16. The base plate 20a may be made of steel.

The first guide member 66 and the second guide member 68 are here exemplified as flanges of the base plate 20a that are bent up from an adjacent area 69 of the base plate 20a. The base plate 20a further comprises a cutout 71 between the first guide member 66 and the second guide member 68. The base plate 20a is further provided with two circular recesses 73. One circular recess 73 is provided at a junction between the first guide member 66, the cutout 71 and the area 69, and one circular recess 73 is provided at a junction between the second guide member 68, the cutout 71 and the area 69. Each circular recess 73 passes through the base plate 20a.

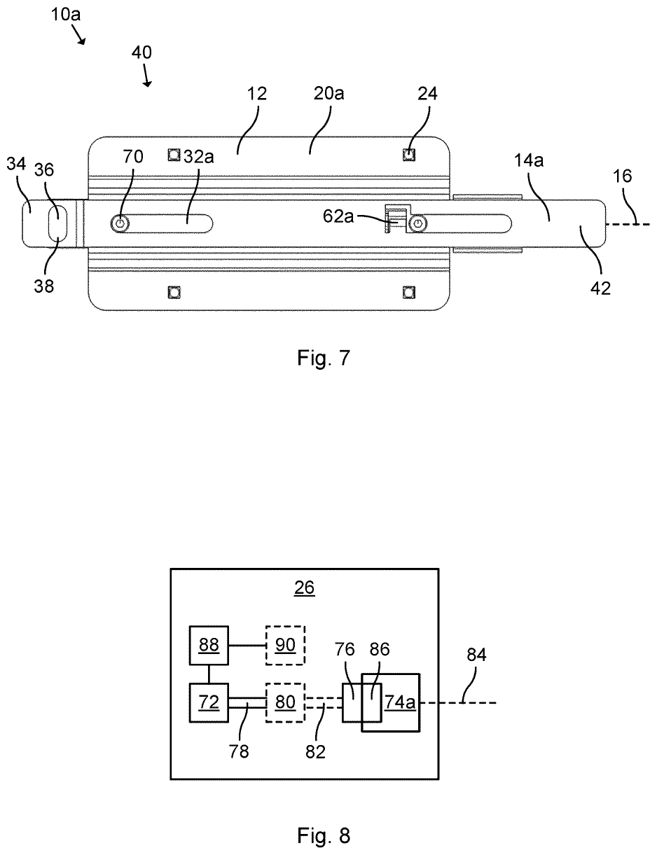

FIG. 7 schematically represents a rear view of the latch assembly 10a. In FIG. 7, two of rear bolts 70 can be seen. Each rear bolt 70 is engaged with a unique slot 32a.

FIG. 8 schematically represents a block diagram of the lock device 26. The lock device 26 comprises an electric motor 72 and a lock element 74a driven by the motor 72. The motor 72 is one example of an electromechanical actuator.

The lock device 26 further comprises a drive feature 76. The drive feature 76 may be fixed to an actuator shaft 78 of the motor 72. Alternatively, the lock device 26 may comprise a transmission 80, such as a gearbox, driven by the actuator shaft 78. In this case, the drive feature 76 may be fixed to a transmission shaft 82 of the transmission 80. In any case, the drive feature 76 is driven by the motor 72.

In this example, the lock element 74a is rotatable about an actuator axis 84. The lock element 74a of this example comprises a driven feature 86. The driven feature 86 is arranged to be contacted and driven by the drive feature 76.

The lock device 26 further comprises a control system 88, such as a printed circuit board (PCB). The control system 88 is configured to control the drive of the motor 72. The lock device 26 may further comprise an energy storage 90, such as one or more batteries, for electrically powering the control system 88.

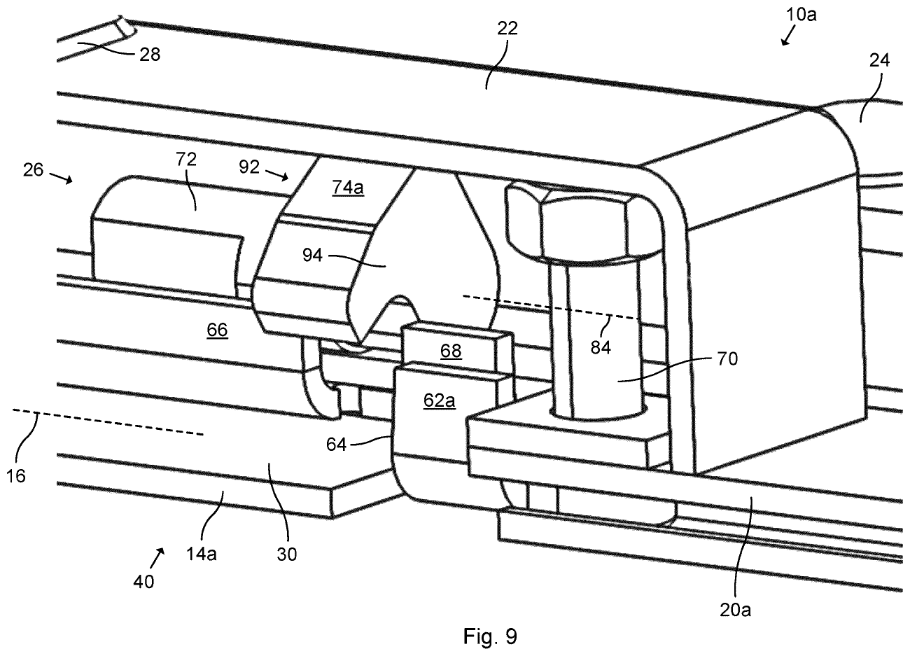

FIG. 9 schematically represents a partial and cross-sectional perspective view of the latch assembly 10a. In FIG. 9, the lock element 74a is in an unlocked position 92 and the latch slider 14a is in the latching position 40. When the lock element 74a is in the unlocked position 92, the user may move the latch slider 14a along the latch axis 16 (here under the lock element 74a) between the latching position 40 and the free position 18, e.g., by grabbing the grip portion 34.

As shown in FIG. 9, the lock element 74a is positioned between the first and second guide members 66 and 68 along the latch axis 16. In this example, the actuator axis 84 is parallel with the latch axis 16. Moreover, the lock element 74a is positioned between the motor 72 and the slider feature 62a when the latch slider 14a is in the latching position 40.

The lock element 74a comprises a lock element side surface 94. The lock element 74a of this example is L-shaped and made of steel. The actuator axis 84 is here positioned at one end of the L-shape.

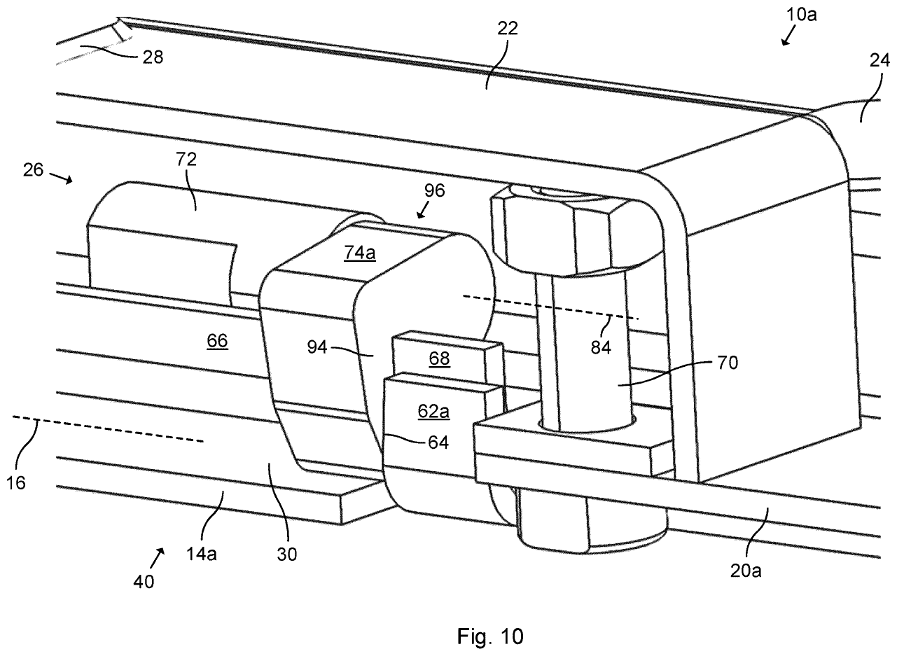

FIG. 10 schematically represents a partial and cross-sectional perspective view of the latch assembly 10a. In FIG. 10, the lock element 74a is in a locked position 96 and the latch slider 14a is in the latching position 40.

In order to lock the latch assembly 10a, the user may force the latch slider 14a from the free position 18 to the latching position 40 when the lock element 74a is in the unlocked position 92, and then push the button 28 to command, e.g., via the control system 88, the motor 72 to drive the lock element 74a from the unlocked position 92 to the locked position 96. Alternatively, the latch assembly 10a may be locked by providing a lock command to the control system 88 from an external device (not shown).

In order to unlock the latch assembly 10a, the user may provide a credential to the control system 88. If the credential is authorized, the control system 88 commands the motor 72 to drive the lock element 74a from the locked position 96 to the unlocked position 92. The user may then force the latch slider 14a from the latching position 40 to the free position 18, e.g., disengaged from the strike 54.

In the locked position 96, the lock element 74a blocks movement of the latch slider 14a from the latching position 40 to the free position 18. Moreover, when the lock element 74a is in the locked position 96 and the latch slider 14a is in the latching position 40, the lock element side surface 94 faces towards the stop surface 64. In case the latch slider 14a is moved towards the free position 18 (to the left in FIG. 10), the lock element 74a will block the latch slider 14a by engaging the slider feature 62a. In this way, the lock element 74a will engage the slider feature 62a to prevent movement of the latch slider 14a from the latching position 40 to the free position 18.

In this example, the lock element 74a contacts the top surface 30 in the locked position 96, here by an end of the L-shape opposite to the actuator axis 84. A raised current to the motor 72 after an expected time can therefore be used as an indicator of when the lock element 74a has reached the locked position 96, as opposed to using a dedicated sensor. Furthermore, should the lock element 74a be stopped by the slider feature 62a when moving towards the locked position 96, the current to the motor 72 will be raised earlier than expected. Thus, also a state when the slider feature 62a is positioned between the first and second guide members 66 and 68 can be detected based on a raised current to the motor 72 without using a sensor.

In this example, the lock element 74a also contacts the base plate 20a in the locked position 96. Due to the circular recesses 73 shown in FIG. 6, it is ensured that the lock element 74a reaches the bottom of the cutout 71 when contacting the base plate 20a.

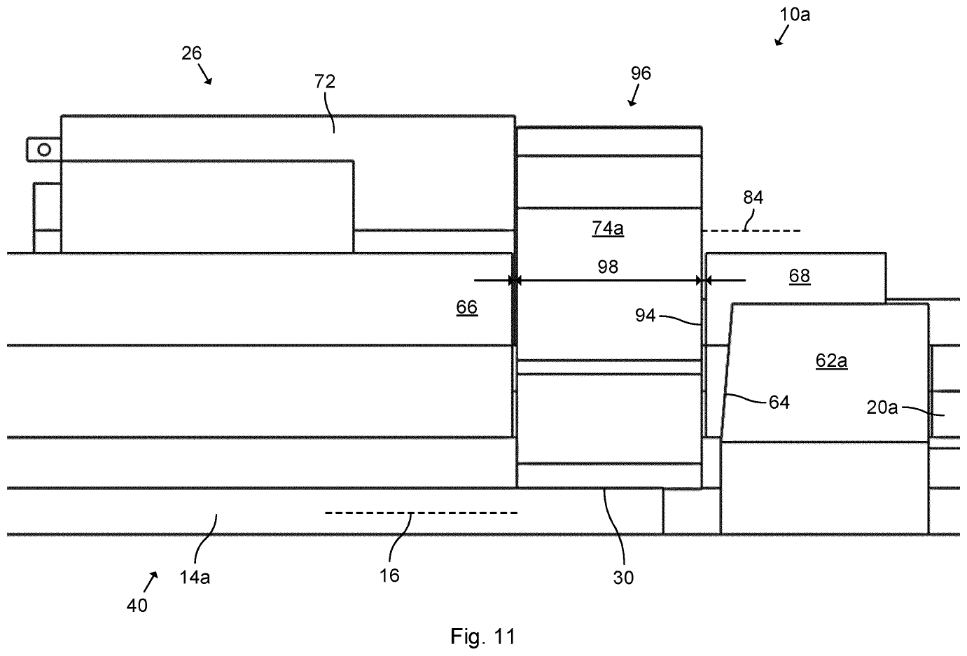

FIG. 11 schematically represents a partial and cross-sectional side view of the latch assembly 10a when the lock element 74a is in the locked position 96 and the latch slider 14a is in the latching position 40. As shown, the lock element 74a is tightly constrained between the first and second guide members 66 and 68. FIG. 11 shows a base clearance 98 between the lock element 74a and the first and second guide members 66 and 68. The base clearance 98 is a sum of the plays (if any) on each side of the lock element 74a to the respective first and second guide members 66 and 68. The base clearance 98 is here parallel with the latch axis 16.

In case the latch slider 14a is forced to move from the latching position 40 towards the free position 18, the stop surface 64 will contact the lock element side surface 94 and force the lock element 74a. However, due to the tight accommodation of the lock element 74a between the first and second guide members 66 and 68, and due to a larger play between the drive feature 76 and the driven feature 86, forces on the latch slider 14a will not damage the motor 72.

FIG. 11 further shows that the lock element side surface 94 and the stop surface 64 are angled relative to each other. The lock element side surface 94 and the stop surface 64 form a V-shape pointing away from the actuator axis 84. In this example, the lock element side surface 94 is perpendicular to the latch axis 16 and the stop surface 64 is angled 5° relative to the lock element side surface 94. Due to the angled stop surface 64, frictional forces counteracting movements of the lock element 74a are reduced. For example, the angled relationship between the lock element side surface 94 and the stop surface 64 enables a low-friction point contact therebetween when the lock element 74a moves from the unlocked position 92 to the locked position 96. A risk of jamming of the motor 72 can thereby be reduced.

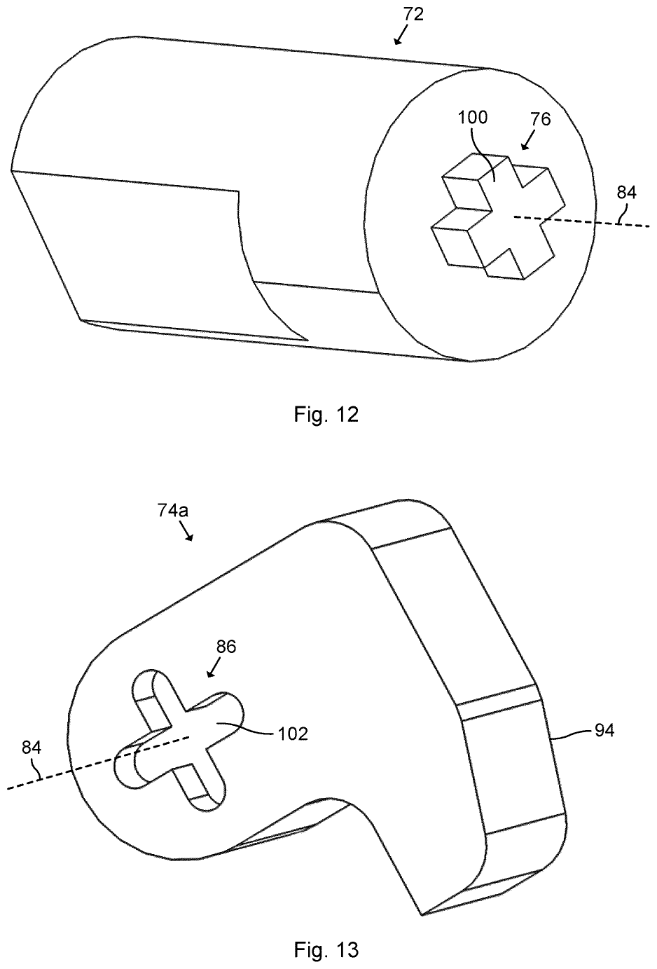

FIG. 12 schematically represents a perspective view of the motor 72. The drive feature 76 is here exemplified as a protruding cross comprising a plurality of teeth 100, here four teeth 100.

FIG. 13 schematically represents a perspective view of the lock element 74a. The driven feature 86 has a shape substantially conforming to the shape of the drive feature 76. The driven feature 86 is here exemplified as a recessed cross comprising a plurality of channels 102. Each channel 102 is arranged to receive one of the teeth 100.

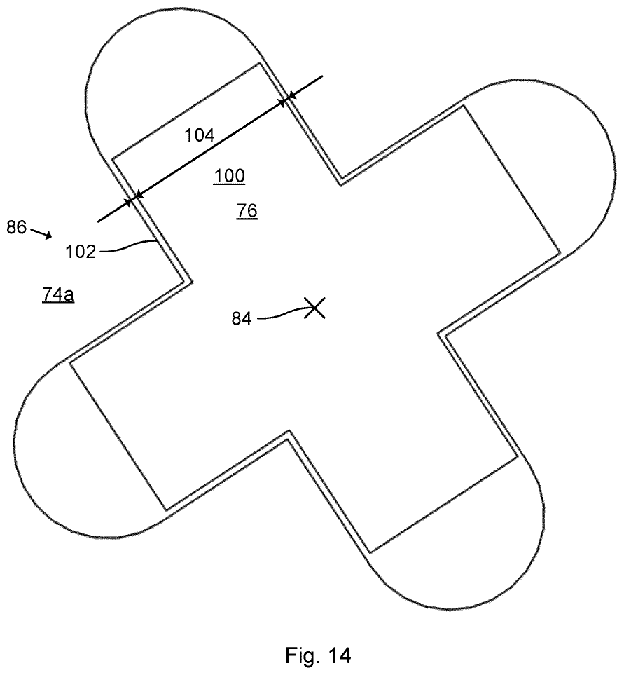

FIG. 14 schematically represents a partial and cross-sectional front view of the drive feature 76 and the driven feature 86. As shown, there is a drive clearance 104 between the drive feature 76 and the driven feature 86, here between each pair of a tooth 100 and an associated channel 102. In the illustrated position of the drive feature 76, the drive clearance 104 is a sum of the plays on each side of each tooth 100 to the associated channel 102. In case the teeth 100 are in driving contact with the sides of the channels 102, the drive clearance 104 is the play on an opposite side of each tooth 100 with respect to the contact side. In any case, the drive clearance 104 is here a circumferential clearance with respect to the actuator axis 84.

The drive clearance 104 is larger than the base clearance 98, such as at least 20% larger, such as at least 50% larger. In case the latch slider 14a is forced from the latching position 40 towards the free position 18 when the lock element 74a is in the locked position 96, the base clearance 98 will therefore be closed before the forces are transmitted by the lock element 74a to the motor 72. In this way, the motor 72 is protected from abuse.

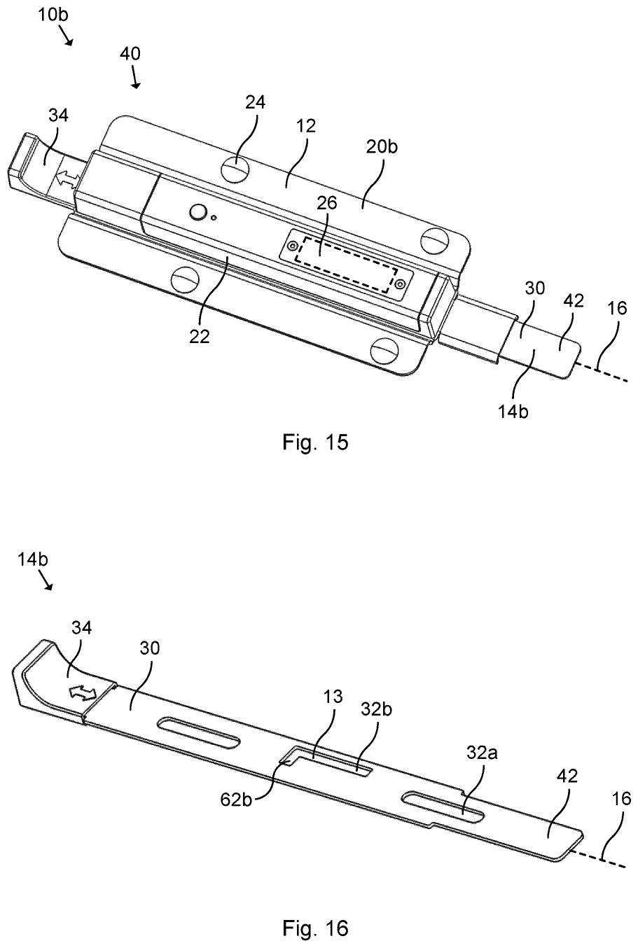

FIG. 15 schematically represents a perspective front view of a latch assembly 10b. The latch assembly 10b differs from the latch assembly 10a by comprising a latch slider 14b and a base plate 20b. The access member system 44 may alternatively comprise the latch assembly 10b.

FIG. 16 schematically represents a perspective front view of the latch slider 14b. The latch slider 14b comprises an opening 13. The opening 13 of this example comprises a slot 32b and a slider feature 62b. The slot 32b is elongated and oriented in parallel with the latch axis 16. The slider feature 62b extends from the slot 32b transverse to the latch axis 16. The opening 13 of this example is thus L-shaped and each of the slot 32b and the slider feature 62b forms a part of the opening 13.

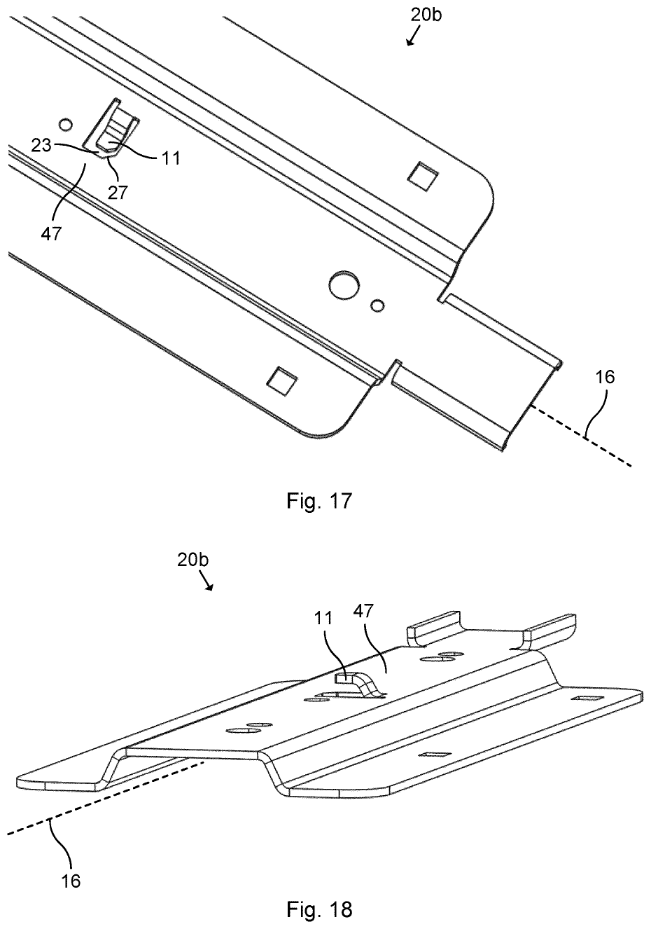

FIG. 17 schematically represents a partial perspective front view of the base plate 20b, and FIG. 18 schematically represents a perspective end view of the base plate 20b. With collective reference to FIGS. 17 and 18, the base plate 20b comprises a protection element 11. The protection element 11 protrudes from the base plate 20b. The entire base plate 20b as shown in FIGS. 17 and 18 can be formed from a single piece of sheet metal, such as steel. The protection element 11 is here exemplified as a flange that is bent downwards from body section 47 of the base plate 20b. A gap 23 is formed between the protection element 11 and the body section 47. The base plate 20b of this example also comprises a chamfered edge 27 next to the protection element 11.

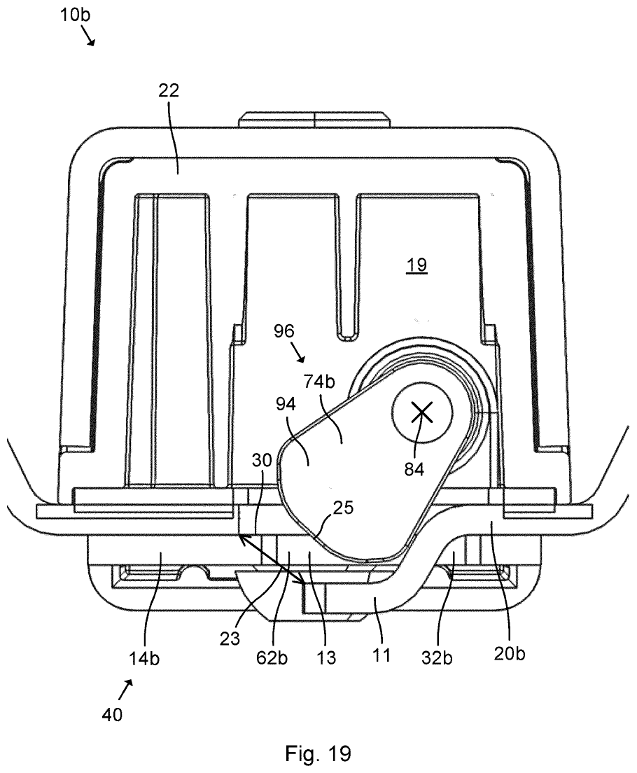

FIG. 19 schematically represents a partial cross-sectional end view of the latch assembly 10b. As shown in FIG. 19, the protection element 11 extends through the opening 13. The protection element 11 thereby protects the lock element 74b to make lock picking more difficult. The protection element 11 is positioned in the slot 32b.

In this example, the lock element 74b contacts the protection element 11 in the locked position 96. A raised current to the motor 72 after an expected time can therefore be used as an indicator of when the lock element 74b has reached the locked position 96, as opposed to using a dedicated sensor. Furthermore, should the lock element 74b be stopped by the latch slider 14b when moving towards the locked position 96, the current to the motor 72 will be raised earlier than expected. Thus, also a state when the slider feature 62b is not aligned with the lock element 74b, i.e., when the latch slider 14b is not in the latching position 40, can be detected based on a raised current to the motor 72 without using a sensor.

Moreover, as can be gathered from FIG. 19, the lock element 74b only has to be positioned above the top surface 30 to adopt the unlocked position 92. An angular distance of the lock element 74b between the unlocked position 92 and the locked position 96 is therefore relatively short, and shorter than an angular distance of the lock element 74a between the unlocked position 92 and the locked position 96, with respect to the actuator axis 84. The latch assembly 10b therefore has an energy efficient operation.

The lock element 74b of this example comprises a planar lock element end surface 25. The lock element end surface 25 is here oriented parallel with the actuator axis 84.

In the locked position 96 of the lock element 74b, the lock element end surface 25 faces the gap 23. A lock picking element potentially introduced through the gap 23 will thereby contact the planar lock element end surface 25, making lock picking more difficult.

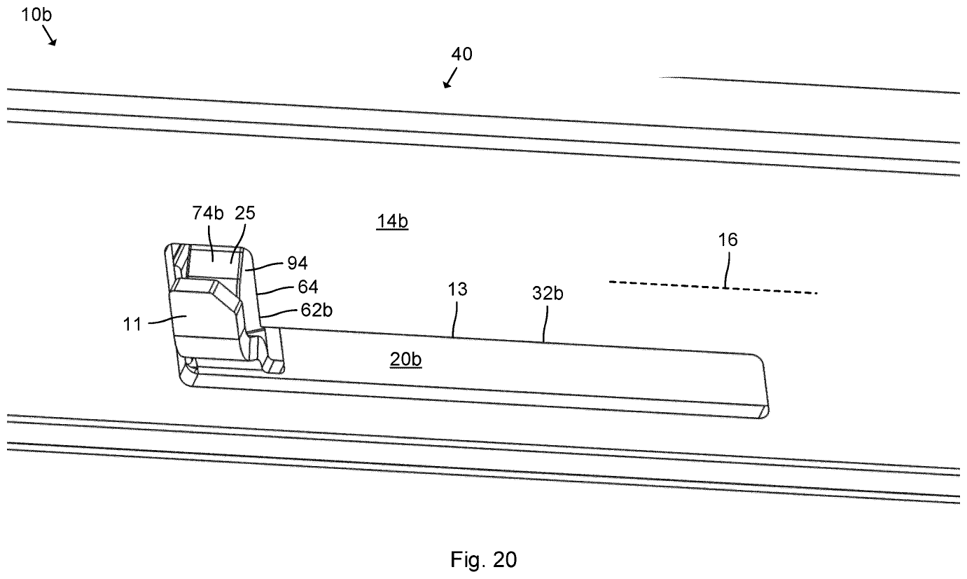

FIG. 20 schematically represents a partial perspective rear view of the latch assembly 10b. It can be gathered from FIG. 20 that the protection element 11 will travel in the slot 32b, in a reference frame of the latch slider 14b, when the latch slider 14b moves between the free position 18 and the latching position 40. Also the slider feature 62b comprises a stop surface 64. In the same way as described in connection with FIG. 11, the lock element side surface 94 and the stop surface 64 can be angled relative to each other.

FIG. 21 schematically represents a perspective side view of the lock element 74b. As shown, the lock element 74b of this example comprises a lock body 29 and two lock element shafts 21a and 21b. The lock element shafts 21a and 21b are concentric with the actuator axis 84. The lock body 29 of this example is substantially droplet-shaped. The droplet shape of the lock element 74b reduces a risk of the lock element 74b to get stuck in the slider feature 62b. The lock element shaft 21b comprises the driven feature 86 arranged to be contacted and driven by the drive feature 76.

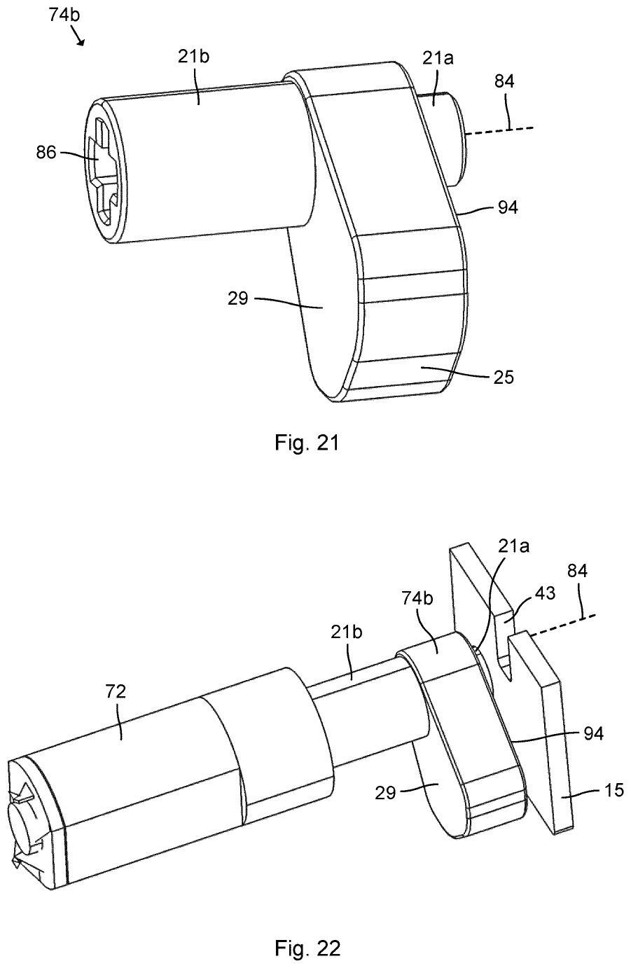

FIG. 22 schematically represents a perspective front view of the motor 72, the lock element 74b and a support plate 15. The support plate 15 is one example of a support structure. The support plate 15 is oriented transverse to the actuator axis 84. On one side of the lock body 29, the lock element 74b is rotationally supported around the actuator axis 84 by engagement between the motor 72 and the lock element shaft 21b. On an opposite side of the lock body 29, the lock element 74b is rotationally supported around the actuator axis 84 by engagement between the support plate 15 and the lock element shaft 21a. A dual support is thereby provided for the lock element 74b. This dual support significantly improves robustness of the lock element 74b. FIG. 22 further shows that the support plate 15 of this example comprises a notch 43.

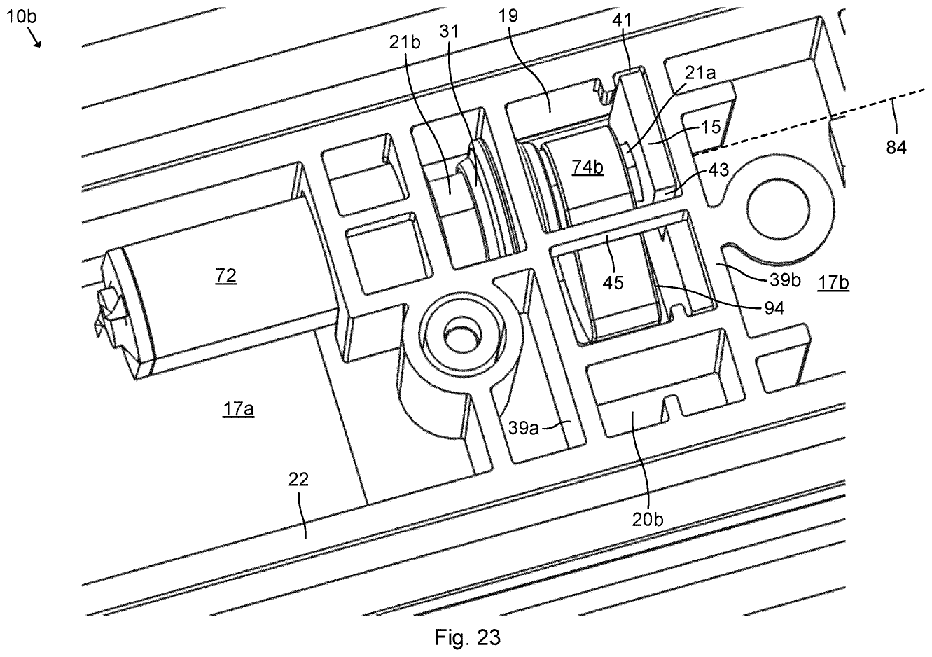

FIG. 23 schematically represents a partial and cross-sectional perspective front view of the latch assembly 10b. In FIG. 23, one example of arrangement of the motor 72 and the lock element 74b in the housing 22 is shown. The housing 22 of this example comprises two closed chambers 17a and 17b, and a lock element chamber 19 therebetween. The closed chambers 17a and 17b are sealingly closed to the lock element chamber 19 to prevent water intrusion into any of the closed chambers 17a and 17b from the lock element chamber 19. One or more gaskets (not shown) may also be provided between the base plate 20b and the door leaf 48, e.g., laterally outside of the latch slider 14b with respect to the latch axis 16, in order to further prevent water intrusion. The lock element 74b is accommodated in the lock element chamber 19. The motor 72 is accommodated in the closed chamber 17a. A power source, such as a battery, may be accommodated in the closed chamber 17b. The closed chambers 17a and 17b may alternatively be constituted by a common closed chamber.

The housing 22 comprises a two walls 39a and 39b delimiting the lock element chamber 19. The housing 22 further comprises a bar 45 extending between the walls 39a and 39b. The lock element shaft 21b passes through the wall 39b and is sealed against the wall 39b and against the base plate 20b by a generally U-shaped gasket 31. The support plate 15 is arranged next to the wall 39b. The support plate 15 can be locked to the housing 22 by inserting the support plate 15 into the housing 22 from below such that the support plate 15 is received in tracks 41 of the housing 22 and such that the bar 45 is received in the notch 43 of the support plate 15, and by fixing the base plate 20b to the housing 22. In this regard, the motor 72, the lock element 74b and the support plate 15 as shown in FIG. 22 may be inserted into the housing 22 as a package.

The lock element 74b may alternatively be rotationally supported in the wall 39. In this case, the support plate 15 can be omitted.

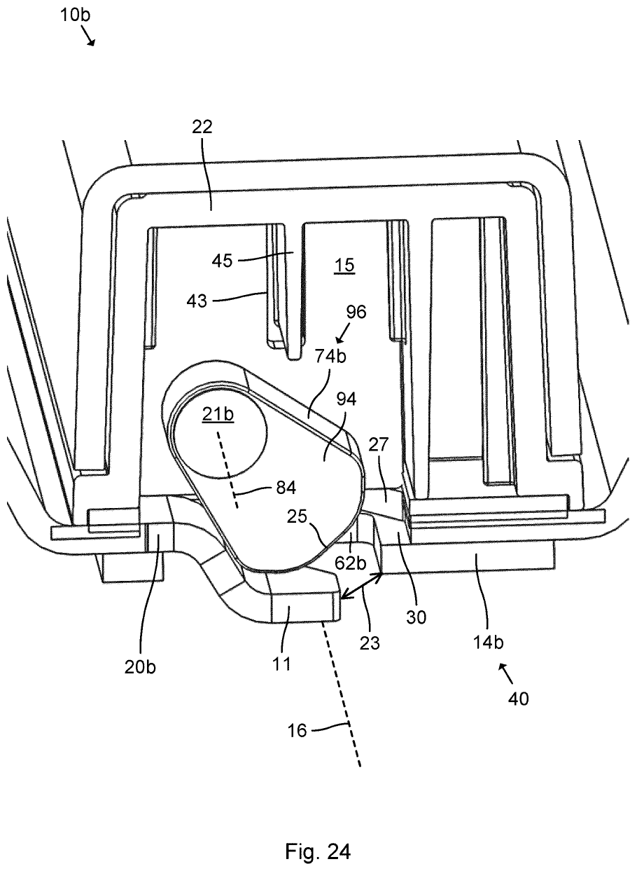

FIG. 24 schematically represents a partial and cross-sectional perspective end view of the latch assembly 10b. As shown in FIG. 24, when the base plate 20b is fixed to the housing 22, the chamfered edge 27 of the base plate 20b prevents the support plate 15 from falling out through the base plate 20b. The support plate 15 is thus supported on the base plate 20b.

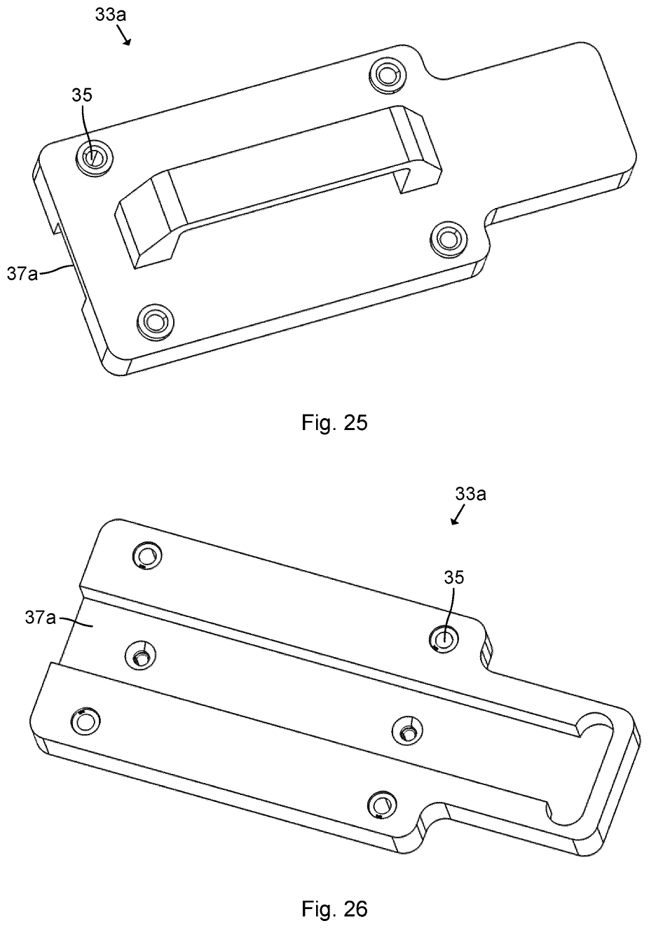

FIG. 25 schematically represents a perspective front view of a removal tool 33a, and FIG. 26 schematically represents a perspective rear view of the removal tool 33a. The removal tool 33a comprises a plurality of bushings 35 and a guiding structure 37a. The guiding structure 37a defines an unequivocal position of the removal tool 33a with respect to the latch assembly 10a or 10b where the bushings 35 are aligned with the front bolts 24. The removal tool 33a can thus be used to localize the front bolts 24. Instead of calling a locksmith, an unexperienced user can remove the latch assembly 10a or 10b by aligning the guiding structure 37a with the latch assembly 10a or 10b and drilling away the front bolts 24 through the bushings 53. The removal tool 33a may be used in connection with a corrugated door leaf 48.

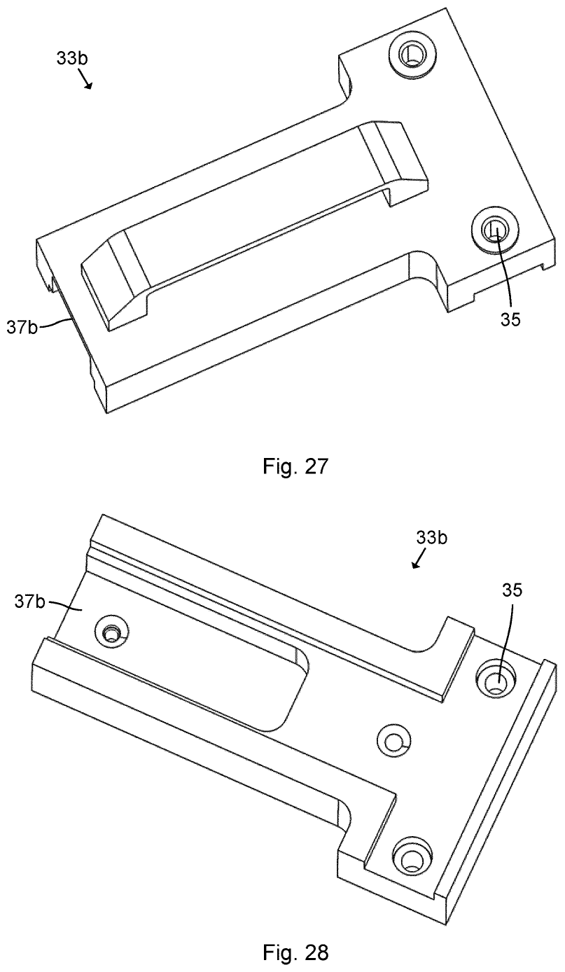

FIG. 27 schematically represents a perspective front view of a removal tool 33b, and FIG. 28 schematically represents a perspective rear view of the removal tool 33b. The removal tool 33b may be used in connection with a flat door leaf 48.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1-32. (canceled)

33. A latch assembly comprising:
a base structure;
an elongated latch slider including a slider feature and being slidable relative to the base structure along a latch axis between a free position and a latching position; and
a lock device including an electromechanical actuator and a lock element movable by the actuator between an unlocked position, where the lock element allows movement of the latch slider between the free position and the latching position, and a locked position for engaging the slider feature to prevent movement of the latch slider from the latching position to the free position;
wherein the latch slider comprises an opening including the slider feature; and
wherein the base structure comprises a protection element extending through the opening and protecting the lock element.

34. The latch assembly according to claim 33, wherein the opening includes a slot extending in parallel with the latch axis, and wherein the protection element is positioned in the slot.

35. The latch assembly according to claim 33, wherein the base structure comprises a base plate, and wherein the protection element is a flange protruding from the base plate.

36. The latch assembly according to claim 33, wherein the lock element is rotatable around an actuator axis.

37. The latch assembly according to claims 33, wherein:
the base structure comprises a base plate, and wherein the protection element is a flange protruding from the base plate;
the lock element is rotatable around an actuator axis;
the base structure comprises a gap between a body section of the base plate and the protection element; and
the lock element comprises a substantially planar lock element end surface substantially parallel with the actuator axis, wherein the lock element end surface faces the gap in the locked position of the lock element.

38. The latch assembly according to claim 35, wherein the base plate is made of a sheet material.

39. A latch assembly comprising:
a base structure;
an elongated latch slider including a slider feature and being slidable relative to the base structure along a latch axis between a free position and a latching position; and
a lock device including an electromechanical actuator and a lock element movable by the actuator between an unlocked position, where the lock element allows movement of the latch slider between the free position and the latching position, and a locked position for engaging the slider feature to prevent movement of the latch slider from the latching position to the free position;
wherein the lock device further comprises a drive feature driven by the actuator;
wherein the lock element comprises a driven feature arranged to be contacted and driven by the drive feature; and
wherein a base clearance between the lock element and the base structure is smaller than a drive clearance between the drive feature and the driven feature.

40. The latch assembly according to claim 39, wherein the base clearance is substantially parallel with the latch axis.

41. The latch assembly according to claim 39, wherein the lock element is rotatable about an actuator axis.

42. The latch assembly according to claim 41, wherein the drive clearance is a circumferential clearance with respect to the actuator axis.

43. The latch assembly according to claim 41, wherein the actuator axis is substantially parallel with the latch axis.

44. The latch assembly according to claim 39, wherein the lock element is L-shaped.

45. The latch assembly according to claim 33, wherein the lock device comprises a button, and wherein the lock device is configured to actuate the actuator to move the lock element from the unlocked position to the locked position in response to manual actuation of the button.

46. The latch assembly according to claim 33, wherein the lock element is rotatable between the unlocked position and the locked position.

47. A latch assembly comprising:
a base structure;
an elongated latch slider including a slider feature and being slidable relative to the base structure along a latch axis between a free position and a latching position; and
a lock device including an electromechanical actuator and a lock element rotatable by the actuator around an actuator axis between an unlocked position, where the lock element allows movement of the latch slider between the free position and the latching position, and a locked position for engaging the slider feature to prevent movement of the latch slider from the latching position to the free position;
wherein the base structure comprises a support structure arranged to support rotation of the lock element around the actuator axis; and
wherein the actuator and the support structure are positioned on opposite sides of the lock element.

48. The latch assembly according to claim 47, wherein the lock element comprises a lock element shaft concentric with the actuator axis, and wherein the support structure supports the lock element shaft.

49. The latch assembly according to claim 47, wherein the base structure comprises a housing, and wherein the support structure is locked to the housing.

50. The latch assembly according to claim 47, wherein the support structure comprises a support plate.

51. The latch assembly according to claim 50, wherein the support plate is oriented transverse to the actuator axis.

52. The latch assembly according to claim 47, wherein the base structure comprises a base plate, and wherein the support structure is supported by the base plate.

53. The latch assembly according to claim 47, wherein the base structure further comprises a lock element chamber at least partly accommodating the lock element, wherein the base structure comprises at least one closed chamber, wherein the actuator is accommodated in one of the at least one closed chamber, and wherein each closed chamber is sealingly closed to the lock element chamber.

54. The latch assembly according to claim 53, wherein the support structure is accommodated in the lock element chamber.

55. An access member system comprising a latch assembly according to claim 33 and an access member, wherein the base structure is fixed to the access member.
